(19) United States
(12) Patent Application Publication
(10) Pub. No.: US 2017/0288580 A1
(43) Pub. Date: Oct. 5, 2017

(54) POWER TOOL AND MOTOR DRIVE SYSTEM THEREOF

(71) Applicant: Johnson Electric S.A., Murten (CH)

(72) Inventors: Hai Bo MA, Hong Kong (CN); Yuk Tung LO, Hong Kong (CN); Jin Zhou CHEN, Shenzhen (CN); Yong Sheng GAO, Shenzhen (CN); Jian Xun ZOU, Shenzhen (CN); Song CHEN, Shenzhen (CN)

(21) Appl. No.: 15/479,836

(22) Filed: Apr. 5, 2017

(30) Foreign Application Priority Data
Apr. 5, 2016 (CN) 2016 1020 6818.8

(51) Int. Cl. H02P 6/16; H02K 7/14; B25F 5/00; H02P 27/08

(52) U.S. Cl. CPC H02P 6/16; H02P 27/08; H02K 7/145; B25F 5/00

(57) ABSTRACT

A motor drive system is provided, which includes: an inverter including an upper-half bridge and a lower-half bridge, the upper-half bridge and the lower-half bridge each including at least two semi-conductive switch elements, where the inverter is configured to convert a voltage provided by a power supply to an alternating current to drive a motor; a microcontroller configured to output a drive signal to the alternately turn on each two of the at least two semi-conductive switch elements of the upper-half bridge and each two of the at least two semi-conductive switch elements of the lower-half bridge when the motor performs braking, whereby a motor winding and the turned-on semi-conductive switch elements form a circuit a capacitor configured to supply power to the microcontroller when the motor performs braking.

### CROSS REFERENCE TO RELATED APPLICATIONS

This non-provisional patent application claims priority under 35 U.S.C. §119(a) to Chinese Patent Application No. CN201610206818.8, filed with the Chinese Patent Office on Apr. 5, 2016 which is incorporated herein by reference in their entirety.

### FIELD

The disclosure relates to a power tool, and particularly to a motor drive system applicable to the power tool.

### BACKGROUND

Power tools are widely used in industry and daily life. Currently, a motor of a power tool is braked by turning on each two or three of semi-conductive switch elements of an upper-half bridge or a lower-half bridge, so as to drive the motor to stop operating. However, during the braking, the power supply is required to continuously supply power to the microcontroller, to enable the microcontroller to output a brake signal to the semi-conductive switch elements of the upper-half bridge or the switches of the lower-half bridge, which causes a waste of electric power.

### SUMMARY

A power tool and a motor drive system are provided according to the present disclosure, where a microcontroller is powered by a capacitor during braking, thereby saving electric power.

A motor drive system is provided according to the embodiments of the present disclosure, which includes:

an inverter including an upper-half bridge and a lower-half bridge, where each of the upper-half bridge and the lower-half bridge includes at least two semi-conductive switch elements, and the inverter is configured to convert a voltage provided by a power supply to an alternating current to drive a motor;

a microcontroller configured to output a drive signal to the alternately turn on each two of the at least two semi-conductive switch elements of the upper-half bridge and each two of the at least two semi-conductive switch elements of the lower-half bridge when the motor performs braking, whereby a motor winding and the turned-on semi-conductive switch elements form a circuit; and

a capacitor configured to supply power to the microcontroller when the motor performs braking.

Preferably, a freewheel diode is coupled in parallel with each of the at least two semi-conductive switch elements; and, where the microcontroller is further configured to output the drive signal to turn off one of two turned-on semi-conductive switch elements, when a rotation speed of the motor is greater than a first predetermined value and less than a second predetermined value and a voltage across the capacitor is lower than a predetermined value during the motor performs braking, wherein the motor winding charges the capacitor via the other of the two turned on semi-conductive switch elements and a freewheel diode coupled in parallel with two terminals of a semi-conductive switch element which is at a same up-and-down side as the turned-off semi-conductive switch element.

Preferably, the motor drive system further includes a diode, where an anode of the diode is coupled with the microcontroller, the capacitor and the inverter, and a cathode of the diode is coupled with the power supply, where when the rotation speed of the motor being greater than the second predetermined value, the motor winding simultaneously charges the capacitor and the power supply.

Preferably, a number of the motor winding is at least two, where when performing braking, the microcontroller determines a first motor winding with a maximum back electromotive force and a second motor winding with a minimum back electromotive force according to a magnetic pole position of a rotor of the motor, and transmits the drive signal to alternately control semi-conductive switch elements of the upper-half bridge and semi-conductive switch elements of the lower-half bridge to be turned on, where the turned-on semi-conductive switch elements of the upper-half bridge include a first semi-conductive switch element which controls the first motor winding and a second semi-conductive switch element which controls the second motor winding, and the turned-on semi-conductive switch elements of the lower-half bridge include a third semi-conductive switch element which controls the first motor winding and a fourth semi-conductive switch element which controls the second motor winding, where the first motor winding and the second motor winding are shorted with each other via the turned-on first semi-conductive switch element and the turned-on second semi-conductive switch element or shorted with each other via the turned-on third semi-conductive switch element and the turned-on fourth semi-conductive switch element.

Preferably, a freewheel diode is coupled in parallel with each of the at least two semi-conductive switch elements; and the microcontroller is further configured to turn off the second semi-conductive switch element when the first semi-conductive switch element and the second semi-conductive switch element of the upper-half bridge are turned on and a voltage across the capacitor is lower than a predetermined value, wherein the first motor winding and the second motor winding charge the capacitor via the first semi-conductive switch element and a freewheel diode coupled in parallel with two terminals of a semi-conductive switch element which is at a same up-and-down side as the second semi-conductive switch element; and turn off the third semi-conductive switch element when the third semi-conductive switch element and the fourth semi-conductive switch element of the lower-half bridge are turned on and the voltage across the capacitor is lower than the predetermined value, wherein the first motor winding and the second motor winding charge the capacitor via the turned-on fourth semi-conductive switch element and a freewheel diode coupled in parallel with two terminals of a semi-conductive switch element which is at a same up-and-down side as the third semi-conductive switch element.

Preferably, the motor drive system further includes a position sensor configured to output a Hall signal according to a magnetic pole position of the rotor, wherein inverter comprises an upper-half bridge and a lower-half bridge, the upper-half bridge comprises a first switch, a second switch and a third switch, and the lower-half bridge comprises a fourth switch, a fifth switch and a sixth switch, wherein a node is formed between the first switch and the fourth switch, a node is formed between the second switch and the fifth switch, and a node is formed between the third switch and the sixth switch, and wherein during the motor is braked, the microcontroller turns on the fifth switch and the sixth switch when the Hall signal outputted by the position sensor is 101, turns on the fourth switch and the fifth switch when the Hall signal outputted by the position sensor is 100, turns on the fourth switch and the sixth switch when the Hall signal outputted by the position sensor is 110, turns on the second switch and the third switch when the Hall signal outputted by the position sensor is 010, turns on the first switch and the second switch when the Hall signal outputted by the position sensor is 011, and turns on the first switch and the third switch when the Hall signal outputted by the position sensor is 001.

Preferably, when performing braking, the microcontroller is further configured to turn off the sixth switch when the Hall signal outputted by the position sensor is 101 and a voltage across the capacitor is lower than a predetermined value, turn off the fourth switch when the Hall signal outputted by the position sensor is 100 and the voltage across the capacitor is lower than the predetermined value, turn off the fourth switch when the Hall signal outputted by the position sensor is 110 and the voltage across the capacitor is lower than the predetermined value, turn off the second switch when the Hall signal outputted by the position sensor is 010 and the voltage across the capacitor is lower than the predetermined value, turn off the second switch when the Hall signal outputted by the position sensor is 011 and the voltage across the capacitor is lower than the predetermined value, and turn off the third switch when the Hall signal outputted by the position sensor is 001 and the voltage across the capacitor is lower than the predetermined value.

Preferably, a number of the motor winding is one, where when performing braking, the microcontroller transmits a PWM signal according to a magnetic pole position of a rotor, so as to alternately control semi-conductive elements of the upper-half bridge to be turned on and semi-conductive elements of the lower-half bridge to be turned on, and the motor winding and the turned-on semi-conductive elements form a circuit.

Preferably, a freewheel diode is coupled in parallel with each of the at least two semi-conductive switch elements; and where the microcontroller is further configured to turn off a semi-conductive switch element which directs a phase current to flow into the motor winding when the semi-conductive switch elements of the upper-half bridge are turned on and a voltage across the capacitor is lower than a predetermined value, wherein the motor winding charges the capacitor via the turned-on semi-conductive switch element and the freewheel diode coupled in parallel with two terminals of a semi-conductive switch element which is at a same up-and-down side as the turned-off semi-conductive switch element of the upper-half bridge; and turn off a semi-conductive switch element which directs the phase current to flow out of the motor winding when the semi-conductive switch elements of the lower-half bridge are turned on and the voltage across the capacitor is lower than the predetermined value, wherein the motor winding charges the capacitor via the turned-on semi-conductive switch element and a freewheel diode coupled in parallel with two terminals of a semi-conductive switch element which is at a same up-and-down side as the turned-off semi-conductive switch element of the lower-half bridge.

Preferably, the motor drive system further includes a position sensor configured to output a Hall signal according to a magnetic pole position of the rotor, wherein the inverter comprises an upper-half bridge and a lower-half bridge, the upper-half bridge comprises a first switch and a second switch, and the lower-half bridge comprises a third switch and a fourth switch, wherein a node is formed between the first switch and the third switch, and a node is formed between the second switch and the fourth switch, and wherein during the motor is braked, the microcontroller turns on the third switch and the fourth switch when the Hall signal outputted by the position sensor is 10, and turns on the first switch and the second switch when the Hall signal outputted by the position sensor is 01.

Preferably, when performing braking, the microcontroller is further configured to turn off the third switch in a case that the Hall signal outputted by the position sensor is 10 and a voltage across the capacitor is lower than a predetermined value, and turn off the first switch in a case that the Hall signal outputted by the position sensor is 01 and the voltage across the capacitor is lower than the predetermined value.

Preferably, wherein during the motor is braked, the capacitor directly supplies power to the microcontroller in a case that a rotation speed of the motor is less than a first predetermined value.

Preferably, the motor drive system further includes a switch coupled between the power supply and the microcontroller, wherein when the switch is closed, the power supply supplies power to the microcontroller via the switch, and when the switch is opened, the switch transmits an opening signal to the microcontroller such that the microcontroller transmits a brake signal to the inverter to control the motor to stop operating, and the power supply stops supplying power to the microcontroller.

A power tool is further provided according to the embodiments of the present disclosure, which includes: a housing, a working head extended out of the housing, a motor for driving the working head, and the motor drive system according to any one of the above.

With the above power tool, when the motor performs braking, the microcontroller is powered by the capacitor without the power supply, thereby saving electric power. Further, when the rotation speed of the motor exceeds the predetermined value, the motor winding charges the power supply, thereby extending the service life of the power supply.

### BRIEF DESCRIPTION OF THE DRAWINGS

FIG. 1 is a block diagram of a motor drive system according to one embodiment.

FIG. 2 is a schematic diagram of a rotation speed variation of a rotor of a motor during braking of the motor.

FIG. 3 is a circuit diagram of a motor drive system according to one embodiment.

FIG. 4 is a waveform diagram of Hall signals and back electromotive forces of the motor drive system of FIG. 3.

FIG. 5 is a schematic diagram of the motor drive system to perform braking when the Hall signal is 101 according to the embodiment.

FIG. 6 is a schematic diagram of the motor drive system to perform braking when the Hall signal is 010 according to one embodiment.

FIG. 7 is a schematic diagram of charging a capacitor of the motor drive system when the Hall signal is 101 according to one embodiment.

FIG. 8 is a schematic diagram of charging the capacitor of the motor drive system when the Hall signal is 010 according to one embodiment.

FIG. 9 is a circuit diagram of a motor drive system according to another embodiment.

FIG. 10 is a schematic diagram of the motor drive system to perform braking when the Hall signal is 10 according to another embodiment.

FIG. 11 is a schematic diagram of the motor drive system to perform braking when the Hall signal is 01 according to another embodiment.

FIG. 12 is a schematic diagram of charging a capacitor of the motor drive system when the Hall signal is 10 according to another embodiment.

FIG. 13 is a schematic diagram illustrating a case of charging a capacitor of the motor drive system when the Hall signal is 01 according to another embodiment.

FIG. 14 is a schematic diagram illustrating a power tool to which the above motor drive system is applied.

### DETAILED DESCRIPTION OF THE EMBODIMENTS

Hereinafter, particular embodiments of the present disclosure are described in detail in conjunction with the drawings, so that technical solutions and other beneficial effects of the present disclosure are apparent. It can be understood that the drawings are provided only for reference and explanation, and are not used to limit the present disclosure. Dimensions shown in the drawings are only for ease of clear description, without defining a proportional relationship.

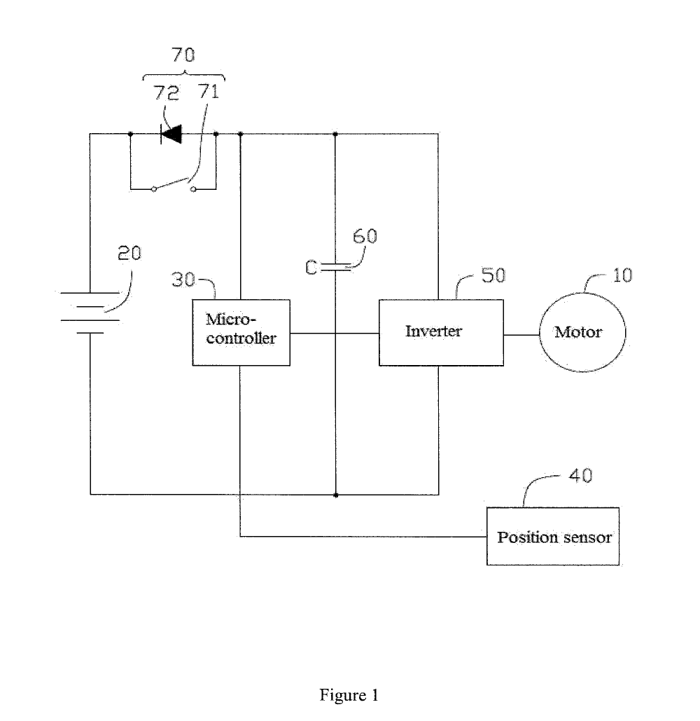

Reference is made to FIG. 1, where a motor drive system according to the present disclosure is configured to drive a motor to operate or to stop operating. In this embodiment, the motor 10 is a brushless direct current (BLDC) motor, which includes a stator and a rotor rotatable relative to the stator, where the stator includes a stator core and a motor winding wound on the stator core. The stator core may be made of soft magnetic materials such as pure iron, cast iron, cast steel, electrical steel, and silicon steel. The rotor is provided with a permanent magnet and a cooling fan.

A power supply 20 supplies electric power to the motor 10. In this embodiment, the power supply 20 may be a rechargeable battery which is detachably mounted within a power tool provided with the motor 10.

The motor drive system includes a microcontroller 30, a position sensor 40, an inverter 50, a capacitor 60 and a switch circuit 70.

The microcontroller 30 is configured to output a signal to control a power mode of the inverter 50. In other embodiments, the motor drive system may further include a voltage regulator which is configured to buck a voltage supplied by the power supply 20 and provide it to the microcontroller 30, and a driver configured to boost or perform current amplification on a signal outputted by the microcontroller 30 and transmit it to the inverter 50. In this embodiment, the output signal is a PWM signal.

The position sensor 40 is coupled with the microcontroller 30 and is configured to detect a magnetic pole position and a rotation speed of the rotor the motor. In this embodiment, the position sensor 40 is a Hall sensor. It should be understood that, in other embodiments, the magnetic pole position and the rotation speed of the rotor of the motor may be detected without a position sensor instead of using the position sensor 40.

The inverter 50 is coupled between the microcontroller 30 and the motor 10. The inverter 50 may be a three-phase inverter including an upper-half bridge and a lower-half bridge, each of which includes multiple semi-conductive switch elements and freewheel diodes each coupled in parallel with two terminals of one of the semi-conductive switch elements. In this embodiment, the semi-conductive switch elements are MOSFETs. The inverter 50 is configured to convert a voltage supplied by the power supply 20 into an alternating current to drive the motor 10.

The capacitor 60 and the inverter 50 are coupled in parallel with two terminals of the switch circuit 70 and the power supply 20. The capacitor 60 is used for filtering and storing electric energy.

The switch circuit 70 includes a switch 71. When the switch 71 is closed, the power supply 20 supplies power to the microcontroller 30 and the inverter 50 and simultaneously charges the capacitor 60 via the switch 71. When the switch 71 is opened, the switch 71 outputs an opening signal to the microcontroller 30, such that the microcontroller 30 outputs a brake signal to the inverter 50. At this time, the capacitor 60 supplies power to the microcontroller 30, such that the inverter 50 controls the motor 10 to stop operating. When the switch 71 is opened, the power supply 20 stops supplying power to the microcontroller 30 and the inverter 50.

In the following, an operation process of the motor drive system is described in detail.

When the switch 71 is closed, the power supply 20 supplies power to the microcontroller 30 and simultaneously charges the capacitor 60 via the switch 71. The microcontroller 30 drives, according to the manganic pole position of the rotor detected by the position sensor 40, the inverter 50 to control the motor 10 to operate.

When the switch 71 is opened, the switch 71 outputs the opening signal to the microcontroller 30. The microcontroller 30 transmits a PWM signal in response to the opening signal to alternately control each two of the semi-conductive switch elements of the upper-half bridge to be turned on and each two of the semi-conductive switch elements of the lower-half bridge to be turned on. The motor winding and the turned-on semi-conductive switch elements form a circuit, in which a phase current is generated. A direction of the phase current is the same as that of the back electromotive force generated by the motor winding when the motor 10 rotates. Therefore, the phase current is capable of hindering the rotation of the motor 10; thereby the braking of the motor 10 is implemented.

Meanwhile, when the switch 71 is opened, the power supply 20 stops supplying power to the microcontroller 30. In a case that the rotation speed of the rotor of the motor detected by the position sensor 40 is less than a first predetermined value (for example, 55 revolutions per minute (rpm)), the capacitor 60 directly supplies power to the microcontroller 30. At this time, since the rotation speed of the rotor of the motor is less than the first predetermined value, the braking of the motor 10 takes a short time. Therefore, the electric power provided by the capacitor 60 is sufficient to drive the microcontroller 30 to enable the inverter 50 to control the motor 10 to stop operating.

When the rotation speed of the rotor of the motor detected by the position sensor 40 is greater than the first predetermined value (for example, 55 rpm) and less than a second predetermined value (for example, 80 rpm), the braking of the motor 10 takes a long time. Therefore, the electric power provided by the capacitor 60 is insufficient to drive the microcontroller 30 to enable the inverter 50 to control the motor 10 to stop operating. In this case, the capacitor 60 needs to be charged. When the microcontroller 30 performs braking, in a case that the rotation speed of the rotor of the motor detected by the position sensor 40 is greater than the first predetermined value (for example, 55 rpm) and a voltage across the capacitor 60 is lower than a predetermined value, the microcontroller 30 further transmits the PWM signal to control one of the two turned-on semi-conductive switch elements to be turned off. The motor winding charges the capacitor 60 via a path formed by the motor winding, the turned on semi-conductive switch element, a freewheel diode coupled in parallel with two terminals of a semi-conductive switch element which is at a same up-and-down side as the turned-off semi-conductive switch element, and the capacitor 60. Thus, when performing braking, the motor 10 further generates electric power to charge the capacitor 60 in a case that the rotation speed of the rotor of the motor is greater than the first predetermined value (for example, 55 rpm) and less than the second predetermined value (for example, 80 rpm), where the microcontroller 30 is powered by the capacitor 60.

In this embodiment, the switch circuit 70 further includes a diode 72, where an anode of the diode 72 is coupled with the microcontroller 30, the capacitor 60 and the inverter 50, and a cathode of the diode 72 is coupled with the power supply 20. The switch 71 is coupled in parallel with the diode 72. When the motor 10 performs braking, in a case that the rotation speed of the rotor of the motor detected by the position sensor 40 is greater than the second predetermined value (for example, 80 revolutions per second), the electric power generated during the braking of the motor 10 is significantly great, such that a voltage across the motor 10 is higher than a voltage of the power supply 20, the diode 72 is turned on, and the motor 10 charges the power supply 20 via the diode 72.

In this way, when the motor 10 performs braking, in a case that the rotation speed of the rotor of the motor is less than the first predetermined value, the capacitor 60 directly supplies power to the microcontroller 30. In a case that the rotation speed of the rotor of the motor is greater than the first predetermined value and less than the second predetermined value, the motor 10 charges the capacitor 60, and the capacitor 60 supplies power to the microcontroller 30. In a case that the rotation speed of the rotor of the motor is greater than the second predetermined value, the motor 10 supplies power to the microcontroller 30 through the capacitor 60 and simultaneously charges the power supply 20.

Specifically, in this embodiment, when performing braking, the microcontroller 30 transmitting the PWM signal to alternately control each two of the semi-conductive switch elements of the upper-half bridge to be turned on and each two of the semi-conductive switch elements of the lower-half bridge to be turned on includes: the microcontroller 30 alternately controls each two of the semi-conductive switch elements of the lower-half bridge of the inverter 50 to be turned on during a first half of a rotation cycle of the motor 10, and each two of the semi-conductive switch elements of the upper-half bridge of the inverter 50 to be turned on during a second half of the rotation cycle of the motor 10.

In other embodiments, when performing braking, the microcontroller 30 transmitting the PWM signal to alternately control each two of the semi-conductive switch elements of the upper-half bridge to be turned on and each two of the semi-conductive switch elements of the lower-half bridge to be turned on includes: the microcontroller 30 alternately controls each two of the semi-conductive switch elements of the upper-half bridge of the inverter 50 to be turned on during the first half of the rotation cycle of the motor 10, and each two of the semi-conductive switch elements of the lower-half bridge of the inverter 50 to be turned on during the second half of the rotation cycle of the motor 10; or, the microcontroller 30 alternately control two semi-conductive switch elements of the upper-half bridge of the inverter 50 to be turned on and two semi-conductive switch elements of the lower-half bridge of the inverter 50 to be turned on.

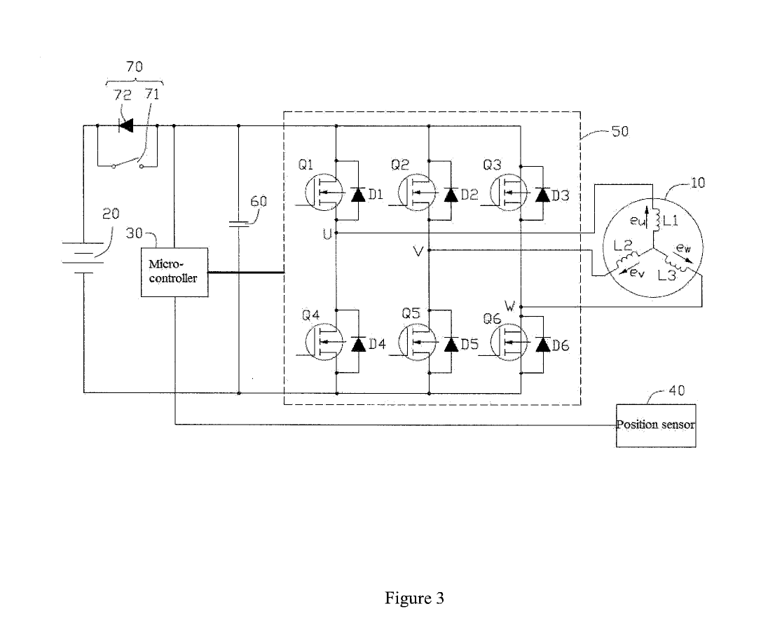

In one embodiment, a number of motor windings is at least two (as shown in FIG. 3). When the motor 10 performs braking, the microcontroller 30 determines a first motor winding with a maximum back electromotive force and a second motor winding with a minimum back electromotive force according to the magnetic pole position of the rotor of the motor. The microcontroller 30 transmits the PWM signal to alternately control semi-conductive switch elements of the upper-half bridge and semi-conductive switch elements of the lower-half bridge to be turned on, where the turned-on semi-conductive switch elements of the upper-half bridge include a first semi-conductive switch element which controls the first motor winding and a second semi-conductive switch element which controls the second motor winding, and the turned-on semi-conductive switch elements of the lower-half bridge include a third semi-conductive switch element which controls the first motor winding and a fourth semi-conductive switch element which controls the second motor winding, such that the first motor winding and the second motor winding are shorted with each other via the turned-on first semi-conductive switch element and the turned-on second semi-conductive switch element or shorted with each other via the turned-on third semi-conductive switch element and the turned-on fourth semi-conductive switch element. The phase current is generated by the back electromotive forces generated by the first motor winding and the second motor winding. Since the first motor winding with the maximum back electromotive force and the second motor winding with the minimum back electromotive force are turned on, a voltage difference formed between the first motor winding and the second motor winding is maximum. Therefore, the phase current flowing through the first motor winding and the second motor winding is maximum, and the generated braking torque is maximum, thus the motor 10 can perform braking more rapidly.

In this embodiment, in a case that the rotation speed of the rotor of the motor detected by the position sensor 40 is greater than the first predetermined value (for example, 55 revolutions per second), when the first semi-conductive switch element and the second semi-conductive switch element of the upper-half bridge are turned on and the voltage across the capacitor 60 is lower than the predetermined value, the microcontroller 30 controls the second semi-conductive switch element which controls the second motor winding to be turned off, where the first motor winding and the second motor winding charge the capacitor 60 via the turned-on first semi-conductive switch element and a freewheel diode coupled in parallel with two terminals of a semi-conductive switch element which is at a same up-and-down side as the second semi-conductive switch element. When the third semi-conductive switch element and the fourth semi-conductive switch element of the lower-half bridge are turned on, and the voltage across the capacitor 60 is lower than the predetermined value, the microcontroller 30 controls the third semi-conductive switch element of the lower-half bridge which controls the first motor winding to be turned off, where the first motor winding and the second motor winding charge the capacitor 60 via the turned-on fourth semi-conductive switch element and a freewheel diode coupled in parallel with two terminals of a semi-conductive switch element which is at a same up-and-down side as the third semi-conductive switch element. Since the phase current flowing through the first motor winding and the second motor winding is maximum, the electric power generated during braking is maximum, and the electric power supplied to the capacitor 60 is maximum.

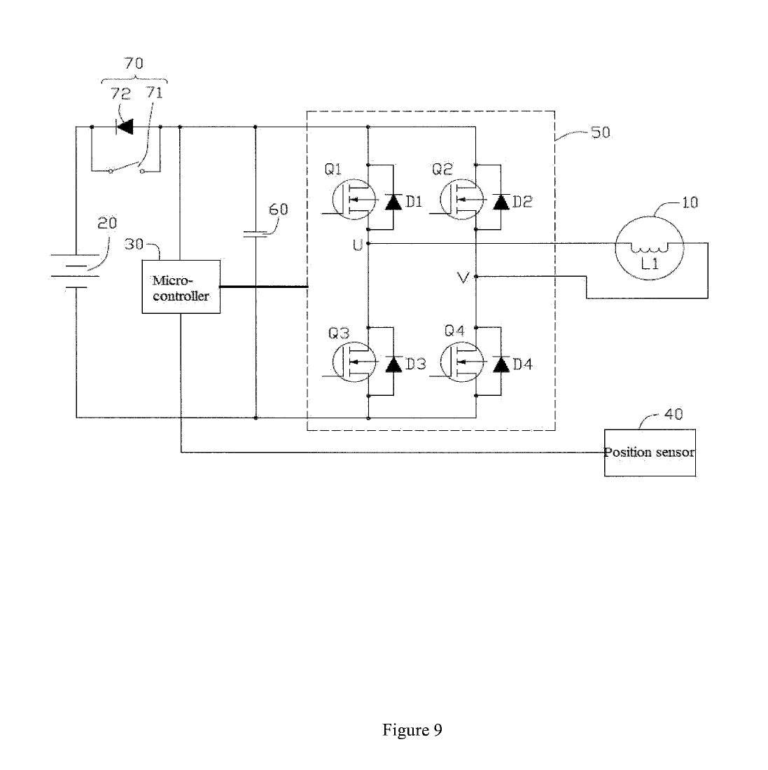

In another embodiment, a number of motor winding is one (as shown in FIG. 9). In this case, the number of the semi-conductive switch elements of the upper-half bridge is two, and the number of the semi-conductive switch elements of the lower-half bridge is two. When the motor 10 performs braking, the microcontroller 30 outputs, according to the magnetic pole position of the rotor detected by the position sensor 40, the PWM signal to alternately control the two semi-conductive switch elements of the upper-half bridge to be turned on and the two semi-conductive switch elements of the lower-half bridge to be turned on. The motor winding and the turned-on semi-conductive switch elements form a circuit, in which the phase current is generated. The direction of the phase current is the same as that of the back electromotive force generated by the motor winding when the motor 10 rotates, thus the motor 10 can perform braking.

In this embodiment, in a case that the rotation speed of the rotor of the motor detected by the position sensor 40 is greater than the first predetermined value (for example, 55 rpm), the microcontroller 30 further controls a semi-conductive switch element which directs the phase current to flow into the motor winding to be turned off, when the semi-conductive switch elements of the upper-half bridge are turned on and the voltage across the capacitor 60 is lower than the predetermined value, where the motor winding charges the capacitor 60 via the turned-on semi-conductive switch element and a freewheel diode coupled in parallel with two terminals of a semi-conductive switch element which is at a same up-and-down side as the turned-off semi-conductive switch element of the upper-half bridge, and controls a semi-conductive switch element which directs the phase current to flow out of the motor winding to be turned off, when the semi-conductive switch elements of the lower-half bridge are turned on and the voltage across the capacitor 60 is lower than the predetermined value, where the motor winding charges the capacitor 60 via the turned-on semi-conductive switch element and a freewheel diode coupled in parallel with two terminals of a semi-conductive switch element which is at a same up-and-down side as the turned-off semi-conductive switch element of the lower-half bridge.

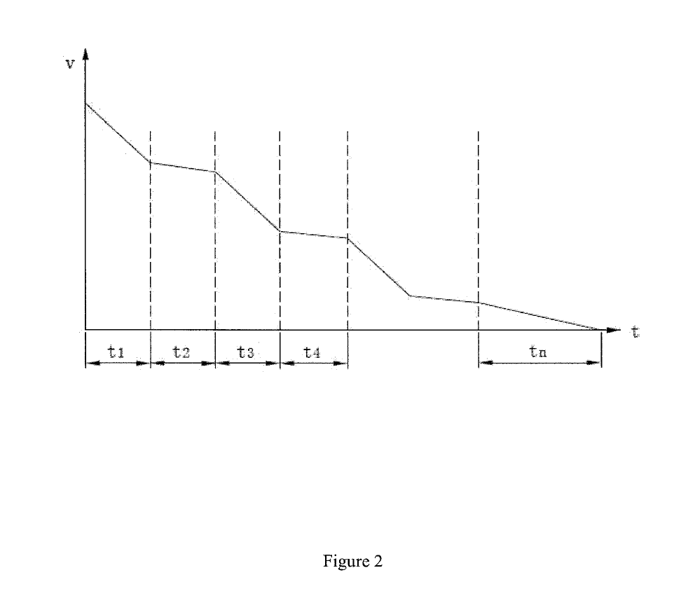

Reference is made to FIG. 2, which is a schematic diagram of a rotation speed variation of a rotor of a motor during braking of the motor, where time is indicated on the horizontal axis by t, and the rotation speed of the rotor of the motor is indicated on the vertical axis by v. During the braking of the motor, t1 and t3 are time periods during which the motor performs braking. During these time periods, the microcontroller 30 transmits the PWM signal to control each two of the semi-conductive switch elements of the upper-half bridge to be turned on, or each two of the semi-conductive switch elements of the lower-half bridge to be turned on. t2 and t4 are time periods during which the motor 10 charges the power supply 20 and/or the capacitor 60. During these time periods, the microcontroller 30 transmits the PWM signal to control one of the turned-on semi-conductive switch elements to be turned off. tn is a time periods during which the motor 10 performs passive braking. During this time period, when the capacitor 60 is insufficient to drive the microcontroller 30 to output a signal, the motor 10 enters the natural braking state. In this embodiment, tn equals to 0, that is, the time required for the motor 10 to perform natural braking is 0. In this case, during braking, the motor 10 repeatedly performs braking and repeatedly charges the capacitor 60 till the motor 10 stops operating. In other embodiments, tn is greater than 0. In this case, the motor 10 performs natural braking till the motor 10 stops operating.

Reference is made to FIG. 3, which is a circuit diagram of a motor drive system according to one embodiment. The inverter 50 is a three-phase full-bridge inverter consisting of semi-conductive switch elements Q1 to Q6, where input terminals of the inverter 50 are coupled in parallel with the capacitor 60, the semi-conductive switch elements Q1 to Q3 form the upper-half bridge, and the semi-conductive switch elements Q4 to Q6 form the lower-half bridge. A first phase current is outputted to the motor winding L1 via a node between the semi-conductive switch element Q1 and the semi-conductive switch element Q4, a second phase current is outputted to the motor winding L2 via a node between the semi-conductive switch element Q2 and the semi-conductive switch element Q5, and a third phase current is outputted to the motor winding L3 via a node between the semi-conductive switch element Q3 and the semi-conductive switch element Q6. Two terminals of each of the semi-conductive switch elements Q1 to Q6 are coupled in parallel with a corresponding one of freewheel diodes D1 to D6.

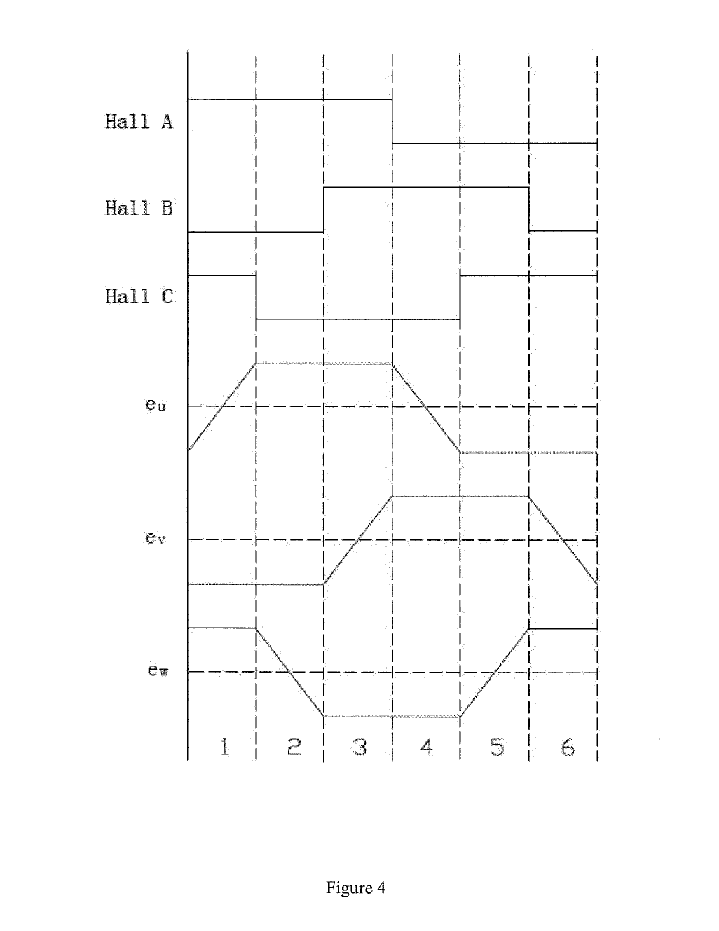

Reference is also made to FIG. 4, which is a waveform diagram of Hall signals and back electromotive forces of the motor drive system of FIG. 3. In FIG. 4, the motor 10 rotates forwardly, a number of position sensors 40 is 3, and the position sensors 40 are positioned 120 degrees from each other. When the motor 10 is driven to operate, the microcontroller 30 outputs, according to the Hall signals, the PWM signal to control the turning on and turning off of the semi-conductive switch elements in the inverter 50, so as to control the power mode of the motor 10, thereby driving the motor 10 to operate. The principle and the process of this operation are the same as those of the operation performed by a conventional electric controller, and are not described in detail herein. In FIG. 4, reference numerals 1, 2, 3, 4, 5, and 6 respectively represent sector 1, sector 2, sector 3, sector 4, sector 5 and sector 6, where in this embodiment, sectors 1 to 3 are sectors which the rotor of the motor covers during a first half of a rotation cycle of the motor 10, and sectors 4 to 6 are sectors which the rotor of the motor covers during a second half of the rotation cycle of the motor 10; Hall A, Hall B and Hall C are Hall signals outputted by 3 position sensors 40; e_{U}, e_{V} and e_{W} are back electromotive forces respectively generated by the motor winding L1, the motor winding L2 and the motor winding L3. When the rotor of the motor is located in a certain sector, the position sensors 40 output a corresponding Hall signal. Therefore, the sectors and the Hall signals outputted by the position sensors 40 have a one-to-one correspondence, and the back electromotive forces and the positions of the rotor of the motor have a one-to-one correspondence. Further, the Hall signals outputted by the position sensors 40 may indicate the positions of the rotor of the motor. Therefore, the back electromotive forces can be determined according to the Hall signals outputted by the position sensors 40.

The microcontroller 30 performs PWM modulation on the upper-half bridge or the lower-half bridge of the inverter 50 according to the Hall signals, so as to perform braking. In this embodiment, the correspondence between the sectors, the Hall signals and the turned-on semi-conductive switch elements is shown in Table 1.

TABLE 1

| Sectors | 1 | 2 | 3 | 4 | 5 | 6 |
|---|---|---|---|---|---|---|
| Hall signals | 101 | 100 | 110 | 010 | 011 | 001 |
| Turned-on | Q5Q6 | Q4Q5 | Q4Q6 | Q2Q3 | Q1Q2 | Q1Q3 |
| semi-conduc- | | | | | | |
| tive switch | | | | | | |
| elements | | | | | | |

When performing braking, the microcontroller 30 obtains the rotation speed of the rotor of the motor detected by the position sensor 40. When the rotation speed of the rotor of the motor detected by the position sensor 40 is less than the first predetermined value, the capacitor 60 supplies power to the microcontroller 30 to enable the microcontroller 30 to drive the inverter 50. In the following, the present disclosure is described by taking a case where the Hall signal is 101 when braking is performed as an example.

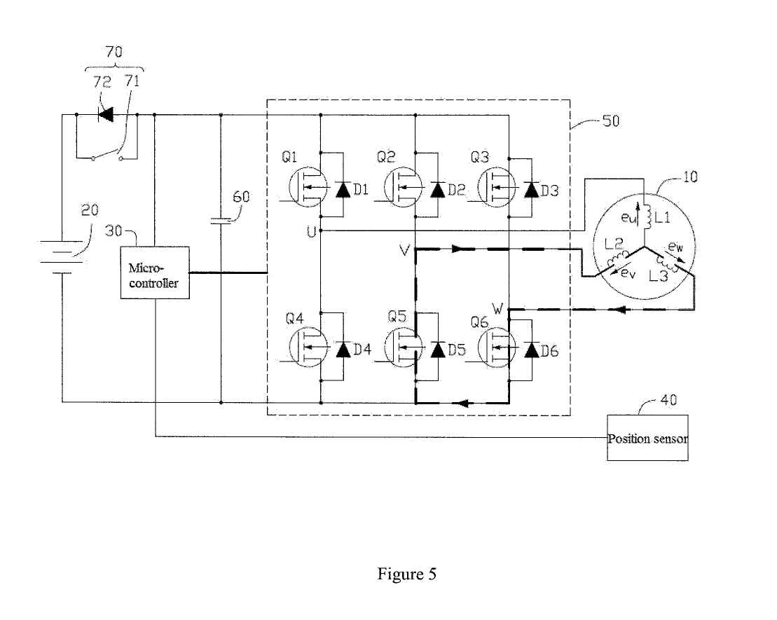

When the microcontroller 30 receives the opening signal, the position sensors 40 sense that the rotor is in the sector 1 and output the Hall signal 101, the first motor winding with the maximum back electromotive force is the motor winding L3, and the second motor winding with the minimum back electromotive force is the motor winding L2. At this time, the third semi-conductive switch element which controls the first motor winding and the fourth semi-conductive switch element which controls the second motor winding in the lower-half bridge are the semi-conductive switch element Q6 and the semi-conductive switch element Q5. The microcontroller 30 turns on the semi-conductive switch element Q6 and the semi-conductive switch element Q5. In this case, the motor winding L2, the motor winding L3, the turned-on semi-conductive switch element Q5 and the turned-on semi-conductive switch element Q6 form a circuit (as shown in FIG. 5), in which the phase current is generated. Since e_{V}<0, e_{W}>0, which are the minimum back electromotive force and the maximum back electromotive force respectively, the voltage difference formed between the motor winding L3 and the motor winding L2 is maximum, the generated phase current is maximum, and the generated braking torque is maximum. The rotation speed of the motor 10 is reduced. When the motor 10 continues rotating such that the rotor of the motor moves from sector 1 to the sector 2, and the position sensors 40 output the Hall signal 100, the principle of the motor 10 performing braking is the same as that of the motor performing braking when the rotor of the motor is in the sector 1. By analogy, when the motor 10 continues rotating such that the rotor of the motor moves to the sector 3, and the position sensors 40 output the Hall signal 110, the principle of the motor 10 performing braking is the same as that of the motor performing braking when the rotor of the motor is in the sector 1.

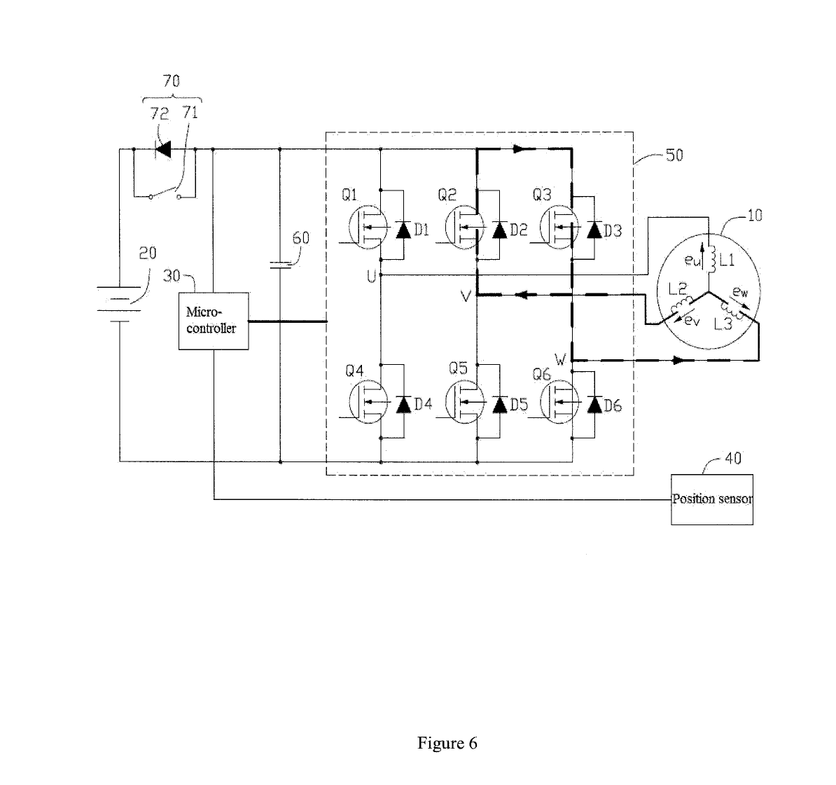

When the motor 10 continues rotating such that the rotor of the motor moves to sector 4, and the position sensors 40 output the Hall signal 010, the first motor winding with the maximum back electromotive force is the motor winding L2, and the second motor winding with the minimum back electromotive force is the motor winding L3. At this time, the first semi-conductive switch element which controls the first motor winding and the second semi-conductive switch element which controls the second motor winding in the upper-half bridge are the semi-conductive switch element Q2 and the semi-conductive switch element Q3. The microcontroller 30 turns on the semi-conductive switch element Q2 and the semi-conductive switch element Q3. In this case, the motor winding L2, the motor winding L3, the turned-on semi-conductive switch element Q2 and the turned-on semi-conductive switch element Q3 form a circuit (as shown in FIG. 6), in which the phase current is generated. Since e_{V}>0, e_{W}<0, which are the maximum back electromotive force and the minimum back electromotive force respectively, the voltage difference formed between the motor winding L2 and the motor winding L3 is maximum, the generated phase current is maximum, and the generated braking torque is maximum. When the motor 10 continues rotating such that the rotor of the motor moves to the sector 5, the microcontroller 30 continues braking; when the motor 10 continues rotating such that the rotor of the motor moves to the sector 6, the microcontroller 30 continues braking. By analogy, the microcontroller 30 cyclically performs braking as the rotor of the motor moves from the sector 1 to the sector 6 till the motor 10 stops operating.

When the position sensors 40 detect that the rotation speed of the rotor of the motor is between the first predetermined value and the second predetermined value and the voltage across the capacitor 60 is lower than the predetermined value, the motor 10 supplies power to the microcontroller 30 through the capacitor 60 during braking.

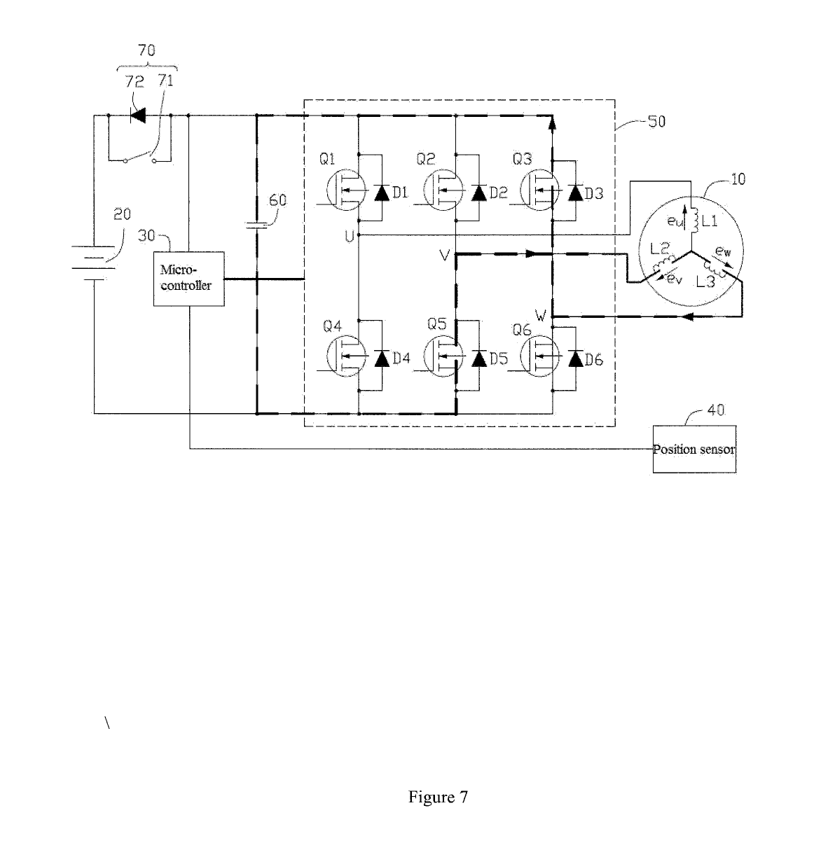

When the microcontroller 30 performs braking and the Hall signal is 101, the microcontroller 30 turns on the semi-conductive switch element Q5 and the semi-conductive switch element Q6, where the operation principle thereof is as described above and is not described in detail herein. The microcontroller 30 further controls the semi-conductive switch element Q6 which controls the motor winding L3 to be turned off. At this time, the freewheel diode coupled in parallel with two terminals of a semi-conductive switch element which is at a same up-and-down side as the semi-conductive switch element Q6 is the freewheel diode D3, and the motor winding L2 and the motor winding L3 charge the capacitor 60 via the freewheel diode D3 coupled in parallel with two terminals of the semi-conductive switch element Q3, the capacitor 60 and the turned-on semi-conductive switch element Q5 (as shown in FIG. 7). The capacitor 60 supplies power to the microcontroller 30, thus when the motor 10 continues rotating such that the rotor of the motor moves to other sectors of the first half of the rotation cycle of the motor 10, the microcontroller 30 can drive the inverter 50 to perform braking and charge the capacitor 60 during braking. In this case, the principle and the process of charging the capacitor 60 are the same as those of charging the capacitor 60 during braking when the Hall signal is 101.

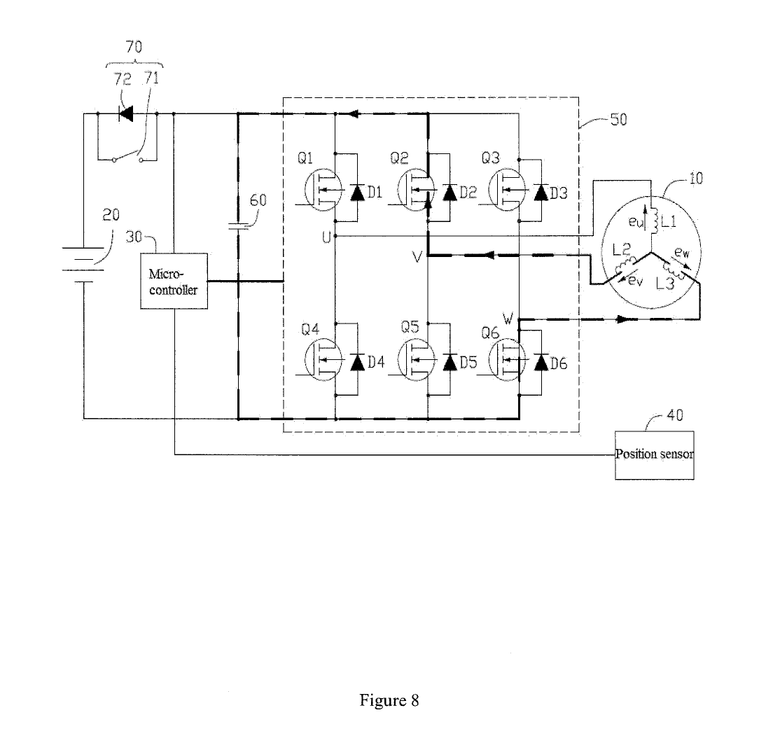

When the motor 10 continues rotating such that the rotor of the motor moves to the sector 4, the position sensors 40 output the Hall signal 010, the microcontroller 30 turns on the semi-conductive switch element Q2 and the semi-conductive switch element Q3 to enable the motor 10 to perform braking. The operation principle thereof is as described above and is not described in detail herein. The microcontroller 30 further controls the semi-conductive switch element Q3 which controls the motor winding L3 to be turned off. At this time, the freewheel diode coupled in parallel with two terminals of a semi-conductive switch element which is at a same up-and-down side as the semi-conductive switch element Q3 is the freewheel diode D6, and the motor winding L2 and the motor winding L3 charge the capacitor 60 via the freewheel diode D6 coupled in parallel with two terminals of the semi-conductive switch element Q6, the capacitor 60 and the turned-on semi-conductive switch element Q2 (as shown in FIG. 8). The capacitor 60 supplies power to the microcontroller 30, thus when the motor 10 continues rotating such that the rotor of the motor moves to other sectors of the second half of the rotation cycle of the motor 10, the microcontroller 30 can drive the inverter 50 to perform braking and charge the capacitor 60 during braking. In this case, the principle and the process of charging the capacitor 60 are the same as those of charging the capacitor 60 during braking when the Hall signal is 010. By analogy, the microcontroller 30 cyclically performs braking and power is cyclically supplied to the microcontroller 30 through the capacitor 60 as the rotor of the motor moves from the sector 1 to the sector 6 till the motor 10 stops operating.

Practically, when the microcontroller 30 receives the opening signal, the rotor may be located in other sectors, for example, the sector 2, where the position sensors 40 output the Hall signal 100 corresponding to this sector, and the microcontroller 30 outputs the brake signal corresponding to the Hall signal 100. At this time, when the motor 10 rotates, the microcontroller 30 cyclically turns on the semi-conductive switch elements not in the order of Q4Q5, Q4Q6, Q2Q3, Q1Q2, Q1Q3, Q5Q6, but in the following order: Q4Q5, Q4Q6, Q5Q6, Q1Q2, Q1Q3, Q2Q3. In other embodiments, the microcontroller 30 cyclically turns on the semi-conductive switch elements in the order listed in Table 1, for example, the microcontroller 30 cyclically turns on the semi-conductive switch elements in the following order: Q4Q5, Q4Q6, Q2Q3, Q1Q2, Q1Q3, Q5Q6.

In another embodiment, the microcontroller 30 may not alternately control each two of the semi-conductive switch elements of the lower-half bridge of the inverter 50 to be turned on during the first half of the rotation cycle of the motor 10, and each two of the semi-conductive switch elements of the upper-half bridge of the inverter 50 to be turned on during the second half of the rotation cycle of the motor 10. The microcontroller 30 may also alternately control each two of the semi-conductive switch elements of the upper-half bridge and each two of the semi-conductive switch elements of the lower-half bridge to be turned on, for example, the microcontroller 30 cyclically turns on the semi-conductive switch elements in the following order: Q5Q6, Q1Q2, Q4Q6, Q2Q3, Q4Q5, Q1Q3. In other embodiments, the microcontroller 30 cyclically turns on the semi-conductive switch elements in the order listed in Table 1, for example, in the following order: Q4Q5, Q4Q6, Q2Q3, Q1Q2, Q1Q3, Q5Q6.

In a case that the rotation speed of the rotor of the motor detected by the position sensors 40 is greater than the second predetermined value, the motor 10 supplies power to the microcontroller 30 through the capacitor 60 and simultaneously charges the power supply 20 during braking.

Reference is made to FIG. 9, which is a circuit diagram of the motor drive system according to another embodiment. In the embodiment, a number of position sensors 40 is 2. The inverter 50 is a single-phase inverter consisting of semi-conductive switch elements Q1 to Q4, where semi-conductive switch elements Q1 and Q2 form the upper-half bridge, and the semi-conductive switch elements Q3 and Q4 form the lower-half bridge. The phase current is outputted to the motor winding L1 via a node between the semi-conductive switch element Q1 and the semi-conductive switch element Q3 and a node between the semi-conductive switch element Q2 and the semi-conductive switch element Q4. Two terminals of each of the semi-conductive switch elements Q1 to Q4 are coupled in parallel with a corresponding one of freewheel diodes D1 to D4.

Since back electromotive forces have a one-to-one correspondence with positions of the rotor of the motor, and the Hall signals outputted by the position sensors 40 indicate the positions of the rotor of the motor, the back electromotive forces can be determined according to the Hall signals outputted by the position sensors 40. When the Hall signal is 10, the back electromotive force e>0; and when the Hall signal is 01, the back electromotive force e<0.

The microcontroller 30 performs PWM modulation on the upper-half bridge or the lower-half bridge of the inverter 50 according to the Hall signals, thereby implementing braking. In this embodiment, the correspondence between the sectors, the Hall signals and the turned-on semi-conductive switch elements is shown in Table 2.

TABLE 2

Sectors

| | 1 | 2 |
|---|---|---|
| Hall signals | 10 | 01 |
| Turned-on semi-conductive | Q3Q4 | Q1Q2 |
| switch elements | | |

When performing braking, the microcontroller 30 obtains the rotation speed of the rotor of the motor detected by the position sensors 40. When the rotation speed of the rotor of the motor detected by the position sensors 40 is less than the first predetermined value, the capacitor 60 supplies power to the microcontroller 30 to enable the microcontroller 30 to drive the inverter 50. In the following, the present disclosure is described by taking a case where the Hall signal is 10 when braking is performed as an example.

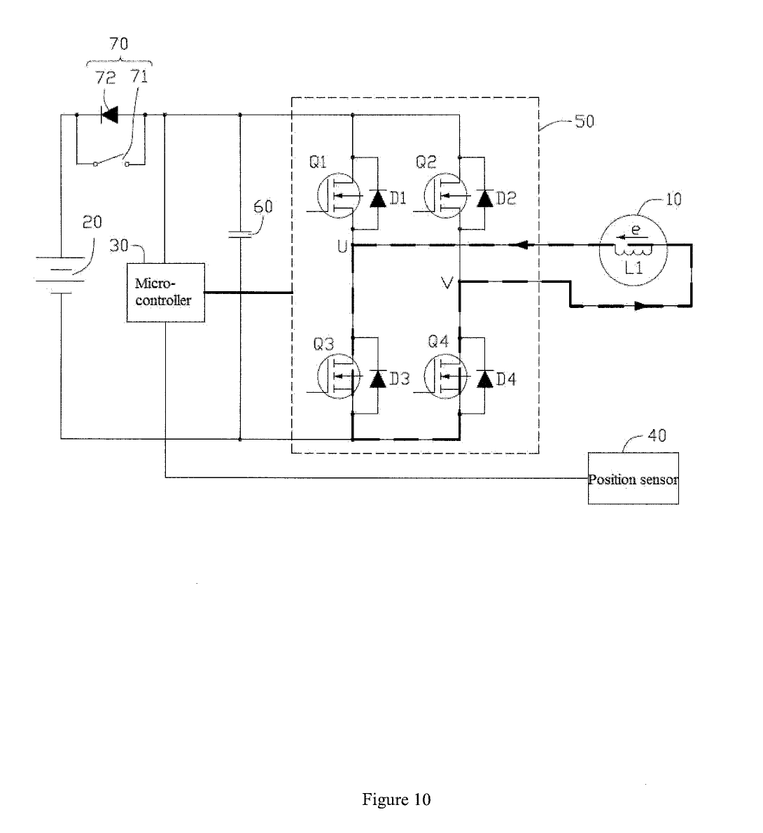

When the microcontroller 30 receives the opening signal, and the position sensors 40 sense that the magnetic pole position of the rotor is in the sector 1 and output the Hall signal 10, the microcontroller 30 turns on the semi-conductive switch element Q3 and the semi-conductive switch element Q4. In this case, the motor winding L1, the turned-on semi-conductive switch element Q3 and the turned-on semi-conductive switch element Q4 form a circuit (as shown in FIG. 10), in which the phase current is generated, thereby performing braking.

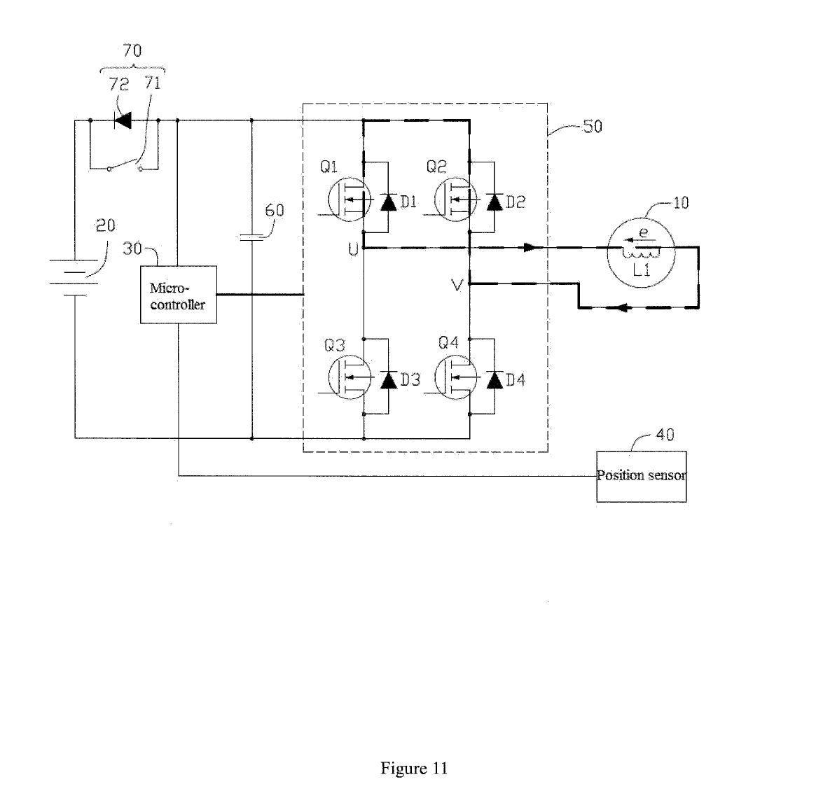

The rotation speed of the motor 10 is reduced. When the motor 10 continues rotating such that the rotor of the motor moves to the sector 2 and the position sensors 40 output the Hall signal 01, the microcontroller 30 turns on the semi-conductive switch element Q1 and the semi-conductive switch element Q2. In this case, the motor winding L1, the turned-on semi-conductive switch element Q1 and the turned-on semi-conductive switch element Q2 form a circuit (an shown in FIG. 11), in which the phase current is generated, thereby performing braking. By analogy, the microcontroller 30 cyclically performs braking as the rotor moves from the sector 1 to the sector 2, till the motor 10 stops operating.

When the position sensors 40 detect that the rotation speed of the rotor of the motor is between the first predetermined value and the second predetermined value, the motor 10 supplies power to the microcontroller 30 through the capacitor 60 during braking.

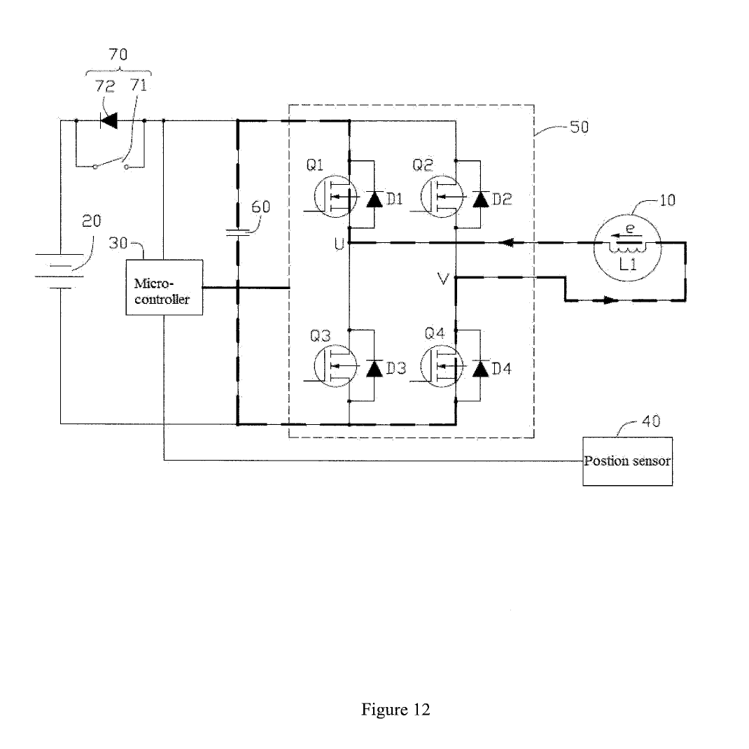

When the microcontroller 30 performs braking and the Hall signal is 10, the microcontroller 30 turns on the semi-conductive switch element Q3 and the semi-conductive switch element Q4, and the operation principle thereof is as described above and is not described in detail herein. At this time, a back electromotive force of the motor winding L1 e>0, the semi-conductive switch element Q3 directs the phase current to flow out of the motor winding L1. The microcontroller 30 controls the semi-conductive switch element Q3 to be turned off. At this time, the motor winding L1 charges the capacitor 60 via the freewheel diode D1 coupled in parallel with two terminals of the semi-conductive switch element Q1, the capacitor 60 and the turned-on semi-conductive switch element Q4 (as shown in FIG. 12), thereby supplying power to the microcontroller 30.

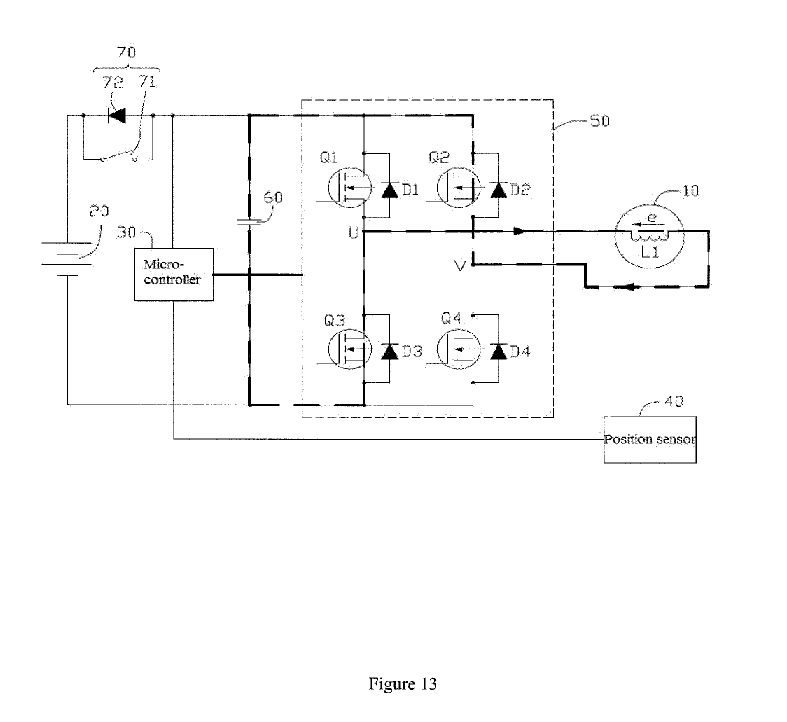

When the motor 10 continues rotating such that the rotor of the motor moves to the sector 2, the position sensors 40 output the Hall signal 01, the microcontroller 30 turns on the semi-conductive switch element Q1 and the semi-conductive switch element Q2 to enable the motor 10 to perform braking, where the operation principle thereof is as described above and is not described in detail herein. At this time, the back electromotive force of the motor winding L1 e<0, and the semi-conductive switch element Q1 directs the phase current to flow into the motor winding L1. The microcontroller 30 controls the semi-conductive switch element Q1 to be turned off. At this time, the motor winding L1 charges the capacitor 60 via the freewheel diode D3 coupled in parallel with two terminals of the semi-conductive switch element Q3, the capacitor 60 and the turned-on semi-conductive switch element Q2 (as shown in FIG. 13), thereby supplying power to the microcontroller 30. By analogy, the microcontroller 30 cyclically performs braking and power is cyclically supplied to the microcontroller 30 through the capacitor 60 as the rotor of the motor moves from the sector 1 to the sector 2 till the motor 10 stops operating.

Practically, when the microcontroller 30 receives the opening signal, the rotor may also be located in other sectors, for example, the sector 2, where the position sensors 40 output the Hall signal 01 corresponding to this sector, and the microcontroller 30 outputs the brake signal corresponding to the Hall signal 01. At this time, when the motor 10 rotates, the microcontroller 30 cyclically turns on the semi-conductive switch elements in the order listed in Table 2, that is, in the following order: Q1Q2, Q3Q4.

In other embodiments, the microcontroller 30 may not alternately control the semi-conductive switch elements of the lower-half bridge of the inverter 50 to be turned on during the first half of the rotation cycle of the motor 10, and the semi-conductive switch elements of the upper-half bridge of the inverter 50 to be turned on during the second half of the rotation cycle of the motor 10. The microcontroller 30 may also alternately control the semi-conductive switch elements of the upper-half bridge of the inverter 50 to be turned on during the first half of the rotation cycle of the motor 10, and the semi-conductive switch elements of the lower-half bridge of the inverter 50 to be turned on during the second half of the rotation cycle of the motor 10. For example, the microcontroller 30 cyclically turns on the semi-conductive switch elements in the following order: Q1Q2, Q3Q4.

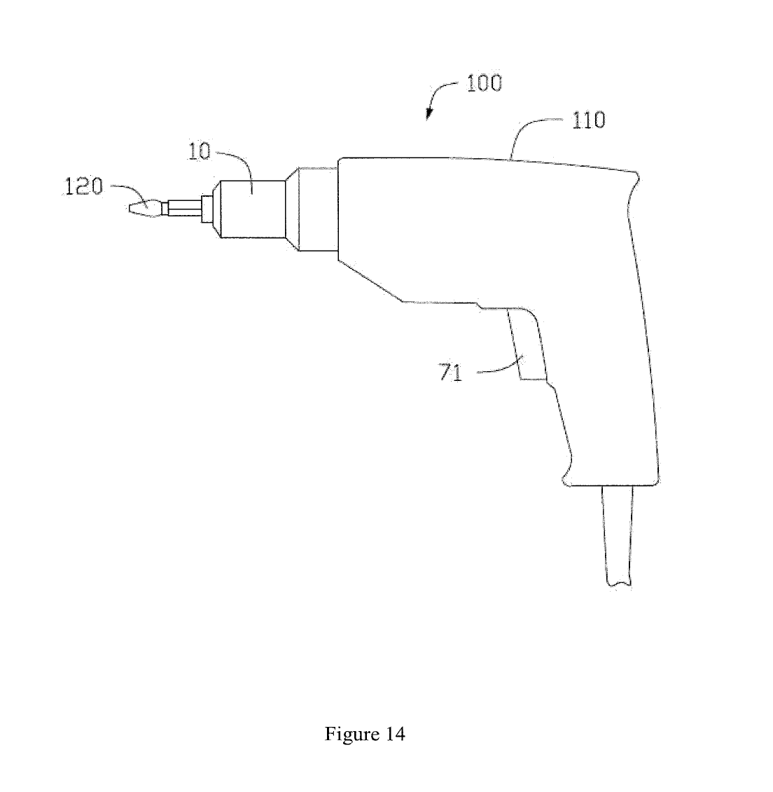

FIG. 14 is a schematic diagram illustrating a power tool, for example, an electric dill, to which the above motor drive system is applied. The electric drill 100 includes a housing 110, a working head 120 extended out of the housing 110, the motor 10 and the motor drive system provided within the housing 110. The switch 71, which is configured to control turning on and turning off of the electric drill 100, is arranged on a handle at a lower portion of the housing 110 and is manually operable by a user. When the switch 71 is pressed, the electric drill 100 is turned on, and when the switch 71 is released, the electric drill 100 is turned off. The above motor drive system is also applicable to power tools such as an electric screw driver, a hand mill and an electric saw.

Therefore, when the motor 10 according to the present disclosure performs braking, power is supplied to the microcontroller 30 by the capacitor 60 without the power supply 20, thereby saving electric power. In addition, when the rotation speed of the motor 10 exceeds a predetermined value, the motor winding charges the power supply 20, thereby extending the service life of the power supply 20. Meanwhile, since semi-conductive switch elements of the upper-half bridge and semi-conductive switch elements of the lower-half bridge are alternately controlled to be turned on during braking, burnout of the semi-conductive switch elements due to a long on-period can be prevented. Further, in a case that the number of motor windings is greater than 2, the motor winding with the maximum back electromotive force and the motor winding with the minimum back electromotive force are shorted with each other, thereby generating the maximum phase current, such that the generated braking torque is maximum, thus braking can be performed more rapidly. In addition, since the generated phase current is maximum, the electric power generated during braking is maximum, and the electric power supplied by the capacitor 60 to the microcontroller 30 is maximum, thus the microcontroller 30 can be driven to control the inverter 50 to perform braking.

What is described above is only preferred embodiments of the present disclosure and is not intended to define the scope of protection of the present disclosure. Any changes, equivalent substitution, improvements and so on made within the spirit and principles of the present disclosure shall fall in the scope of protection of the present disclosure. For example, the motor drive system according to the present disclosure is applicable to driving not only the brushless direct current motor, but also other kinds of motors such as a brushed direct current motor and an alternating current motor.

1. A motor drive system, comprising:
an inverter comprising an upper-half bridge and a lower-half bridge, wherein each of the upper-half bridge and the lower-half bridge comprises at least two semi-conductive switch elements, and the inverter is configured to convert a voltage provided by a power supply to an alternating current to drive a motor;
a microcontroller configured to output a drive signal to the alternately turn on each two of the at least two semi-conductive switch elements of the upper-half bridge and each two of the at least two semi-conductive switch elements of the lower-half bridge when the motor performs braking, whereby a motor winding and the turned-on semi-conductive switch elements form a circuit; and
a capacitor configured to supply power to the microcontroller when the motor performs braking.

2. The motor drive system according to claim 1, wherein:
a freewheel diode is coupled in parallel with each of the at least two semi-conductive switch elements; and
the microcontroller is further configured to output the drive signal to turn off one of two turned-on semi-conductive switch elements, when a rotation speed of the motor is greater than a first predetermined value and less than a second predetermined value and a voltage across the capacitor is lower than a predetermined value during the motor performs braking, wherein the motor winding charges the capacitor via the other of the two turned on semi-conductive switch elements and a freewheel diode coupled in parallel with two terminals of a semi-conductive switch element which is at a same up-and-down side as the turned-off semi-conductive switch element.

3. The motor drive system according to claim 2, further comprising a diode, wherein an anode of the diode is coupled with the microcontroller, the capacitor and the inverter, and a cathode of the diode is coupled with the power supply, wherein when the rotation speed of the motor being greater than the second predetermined value, the motor winding simultaneously charges the capacitor and the power supply.

4. The motor drive system according to claim 1, wherein:
a number of the motor winding is at least two, wherein when performing braking, the microcontroller determines a first motor winding with a maximum back electromotive force and a second motor winding with a minimum back electromotive force according to a magnetic pole position of a rotor of the motor, and transmits the drive signal to alternately control semi-conductive switch elements of the upper-half bridge and semi-conductive switch elements of the lower-half bridge to be turned on, wherein the turned-on semi-conductive switch elements of the upper-half bridge comprise a first semi-conductive switch element which controls the first motor winding and a second semi-conductive switch element which controls the second motor winding, and the turned-on semi-conductive switch elements of the lower-half bridge comprise a third semi-conductive switch element which controls the first motor winding and a fourth semi-conductive switch element which controls the second motor winding, wherein the first motor winding and the second motor winding are shorted with each other via the turned-on first semi-conductive switch element and the turned-on second semi-conductive switch element or shorted with each other via the turned-on third semi-conductive switch element and the turned-on fourth semi-conductive switch element.

5. The motor drive system according to claim 4, wherein:
a freewheel diode is coupled in parallel with each of the at least two semi-conductive switch elements; and
the microcontroller is further configured to turn off the second semi-conductive switch element when the first semi-conductive switch element and the second semi-conductive switch element of the upper-half bridge are turned on and a voltage across the capacitor is lower than a predetermined value, wherein the first motor winding and the second motor winding charge the capacitor via the first semi-conductive switch element and a freewheel diode coupled in parallel with two terminals of a semi-conductive switch element which is at a same up-and-down side as the second semi-conductive switch element; and turn off the third semi-conductive switch element when the third semi-conductive switch element and the fourth semi-conductive switch element of the lower-half bridge are turned on and the voltage across the capacitor is lower than the predetermined value, wherein the first motor winding and the second motor winding charge the capacitor via the turned-on fourth semi-conductive switch element and a freewheel diode coupled in parallel with two terminals of a semi-conductive switch element which is at a same up-and-down side as the third semi-conductive switch element.

6. The motor drive system according to claim 4, further comprising:
a position sensor configured to output a Hall signal according to a magnetic pole position of the rotor, wherein inverter comprises an upper-half bridge and a lower-half bridge, the upper-half bridge comprises a first switch, a second switch and a third switch, and the lower-half bridge comprises a fourth switch, a fifth switch and a sixth switch, wherein a node is formed between the first switch and the fourth switch, a node is formed between the second switch and the fifth switch, and a node is formed between the third switch and the sixth switch, and wherein during the motor is braked, the microcontroller turns on the fifth switch and the sixth switch when the Hall signal outputted by the position sensor is 101, turns on the fourth switch and the fifth switch when the Hall signal outputted by the position sensor is 100, turns on the fourth switch and the sixth switch when the Hall signal outputted by the position sensor is 110, turns on the second switch and the third switch when the Hall signal outputted by the position sensor is 010, turns on the first switch and the second switch when the Hall signal outputted by the position sensor is 011, and turns on the first switch and the third switch when the Hall signal outputted by the position sensor is 001.

7. The motor drive system according to claim 6, wherein:
when performing braking, the microcontroller is further configured to turn off the sixth switch when the Hall signal outputted by the position sensor is 101 and a voltage across the capacitor is lower than a predetermined value, turn off the fourth switch when the Hall signal outputted by the position sensor is 100 and the voltage across the capacitor is lower than the predetermined value, turn off the fourth switch when the Hall signal outputted by the position sensor is 110 and the voltage across the capacitor is lower than the predetermined value, turn off the second switch when the Hall signal outputted by the position sensor is 010 and the voltage across the capacitor is lower than the predetermined value, turn off the second switch when the Hall signal outputted by the position sensor is 011 and the voltage across the capacitor is lower than the predetermined value, and turn off the third switch when the Hall signal outputted by the position sensor is 001 and the voltage across the capacitor is lower than the predetermined value.

8. The motor drive system according to claim 1, wherein:
a number of the motor winding is one, wherein when performing braking, the microcontroller transmits a PWM signal according to a magnetic pole position of a rotor, so as to alternately control semi-conductive elements of the upper-half bridge to be turned on and semi-conductive elements of the lower-half bridge to be turned on, wherein the motor winding and the turned-on semi-conductive elements form a circuit.

9. The motor drive system according to claim 8, wherein:
a freewheel diode is coupled in parallel with each of the at least two semi-conductive switch elements; and
the microcontroller is further configured to turn off a semi-conductive switch element which directs a phase current to flow into the motor winding when the semi-conductive switch elements of the upper-half bridge are turned on and a voltage across the capacitor is lower than a predetermined value, wherein the motor winding charges the capacitor via the turned-on semi-conductive switch element and the freewheel diode coupled in parallel with two terminals of a semi-conductive switch element which is at a same up-and-down side as the turned-off semi-conductive switch element of the upper-half bridge; and turn off a semi-conductive switch element which directs the phase current to flow out of the motor winding when the semi-conductive switch elements of the lower-half bridge are turned on and the voltage across the capacitor is lower than the predetermined value, wherein the motor winding charges the capacitor via the turned-on semi-conductive switch element and a freewheel diode coupled in parallel with two terminals of a semi-conductive switch element which is at a same up-and-down side as the turned-off semi-conductive switch element of the lower-half bridge.

10. The motor drive system according to claim 8, further comprising:
a position sensor configured to output a Hall signal according to a magnetic pole position of the rotor, wherein the inverter comprises an upper-half bridge and a lower-half bridge, the upper-half bridge comprises a first switch and a second switch, and the lower-half bridge comprises a third switch and a fourth switch, wherein a node is formed between the first switch and the third switch, and a node is formed between the second switch and the fourth switch, and wherein during the motor is braked, the microcontroller turns on the third switch and the fourth switch when the Hall signal outputted by the position sensor is 10, and turns on the first switch and the second switch when the Hall signal outputted by the position sensor is 01.

11. The motor drive system according to claim 10, wherein:
when performing braking, the microcontroller is further configured to turn off the third switch in a case that the Hall signal outputted by the position sensor is 10 and a voltage across the capacitor is lower than a predetermined value, and turn off the first switch in a case that the Hall signal outputted by the position sensor is 01 and the voltage across the capacitor is lower than the predetermined value.

12. The motor drive system according to claim 1, wherein during the motor is braked, the capacitor directly supplies power to the microcontroller in a case that a rotation speed of the motor is less than a first predetermined value.

13. The motor drive system according to claim 1, further comprising a switch coupled between the power supply and the microcontroller, wherein when the switch is closed, the power supply supplies power to the microcontroller via the switch, and when the switch is opened, the switch transmits an opening signal to the microcontroller such that the microcontroller transmits a brake signal to the inverter to control the motor to stop operating, and the power supply stops supplying power to the microcontroller.

14. A power tool, comprising: a housing, a working head extended out of the housing, a motor for driving the working head, and the motor drive system according to claim 1.
